(19) United States
(12) Patent Application Publication
(10) Pub. No.: US 2024/0246569 A1
(43) Pub. Date: Jul. 25, 2024

(54) TRAJECTORY PREDICTION THROUGH SEMANTIC INTERACTION

(71) Applicant: GM Cruise Holdings LLC, San Francisco, CA (US)

(72) Inventors: Abbas Shikari, New York, NY (US); Prathyush Katukojwala, Pasadena, CA (US)

(21) Appl. No.: 18/158,226

(22) Filed: Jan. 23, 2023

(51) Int. Cl. B60W 60/00

(52) U.S. Cl. CPC B60W 60/0015; B60W 2554/4049

(57) ABSTRACT

Aspects of the subject technology relate to systems, methods, and computer-readable media for predicting trajectories of agents in an autonomous vehicle (“AV”) environment based on semantic interactions between the agents and AVs. Raw data of an AV operating in an environment can be accessed. An interaction model that models semantic interactions between agents in driving environments can be accessed. A probability distribution of various semantic interactions of an agent with respect to the AV in the environment can be identified through application of the interaction model. Different trajectories of the agent in the environment can be predicted according to the probability distribution of the various semantic interactions of the agent with respect to the AV through application of the interaction model.

### BACKGROUND

### 1. Technical Field

The present disclosure generally relates to agent trajectory prediction in an autonomous vehicle (“AV”) environment and, more specifically, to agent trajectory prediction based on semantic interaction in the AV environment.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates an example AV operating environment with interactions between agents, according to some examples of the present disclosure;

FIG. 1B shows the example operating environment at a later time in relation to the time in the operating environment represented by FIG. 1A, according to some examples of the present disclosure;

FIG. 2 illustrates a flowchart for an example method of predicting trajectories of an agent with respect to an AV based on predicted semantic interactions of the agent in an environment, according to some examples of the present disclosure;

FIG. 3 illustrates a flowchart for an example method of labeling data and training an interaction model based on the labeled data, according to some examples of the present disclosure;

FIG. 4 illustrates an example system environment that can be used to facilitate AV dispatch and operations, according to some aspects of the disclosed technology;

FIG. 5 illustrates an example of a deep learning neural network that can be used to implement the interaction models described herein, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

AVs can be controlled through software stacks that implement machine learning techniques to control the AVs based on sensor data that is captured during operation of the AVs. In controlling the AVs, the software stacks can predict the trajectories of agents or objects in operating environments of the AVs. In turn, the AVs can be controlled based on the predicted trajectories of the agents in the operating environments of the AVs. Software stacks can predict both the probability that an agent will perform a specific maneuver and a trajectory of the agent relative to an AV if the agent performs such maneuver based on geometric considerations in relation to the AV. These can be referred to as geometric-based trajectory prediction modes are defined by semantic maneuvers, as will be discussed in greater detail later.

The geometric-based trajectory prediction modes have deficiencies with respect to predicting trajectories of agents in an environment. Specifically, the geometric-based trajectory prediction modes have deficiencies with respect to predicting trajectories of agents in an environment with respect to AVs operating in the environment. In particular, problems arise in that the geometric-based trajectory prediction modes can fail to properly account for specific interactions between agents and AVs in an environment when predicting trajectories of the agents relative to the AVs.

The disclosed technology addresses the problems associated with predicting trajectories of agents relative to each other and AVs in an operating environment by accounting for semantic interactions between agents and AVs. A semantic interaction, as used herein, includes an interaction between different agents or agents and AVs that is describable through linguistic or logical explanation. Specifically, a semantic interaction can include an agent, or otherwise an AV, asserting to occupy a position that is in a trajectory of another agent or is otherwise capable of being occupied by the another agent during operation of both agents in the environment. For example, an assert interaction for a first car can include when the first car and a second car are stopped at an intersection, that the first car moves into the intersection ahead of the second car. A semantic interaction can also include an agent yielding to another agent to occupy a position that is capable of being occupied by the agent. For example, a yield interaction for a first car can include when the first car and a second car are stopped at an intersection, that the first car lets the second car move into the intersection ahead of the first car.

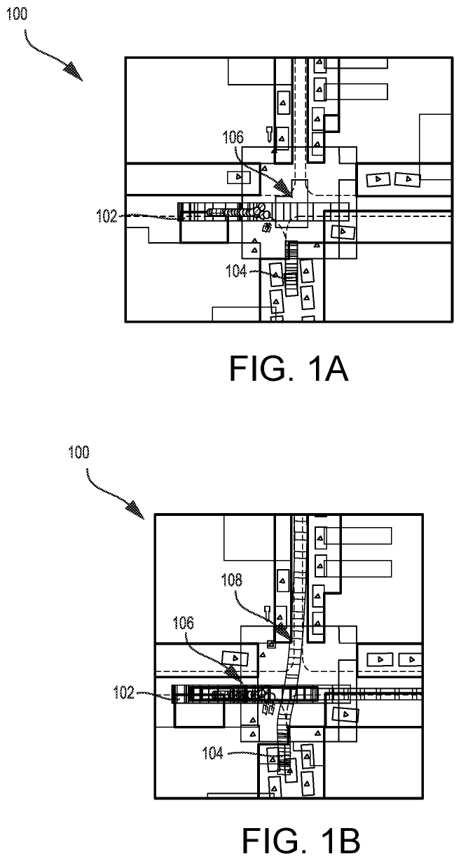

FIG. 1A illustrates an example AV operating environment 100 with interactions between agents. Agents, as used herein, include objects that are capable of interacting in an environment in which an AV operates. Specifically, agents include objects that can move to interact in an AV operational environment. For example, agents can include AVs themselves, other vehicles, pedestrians, and bicyclists in an AV operational environment.

In interacting with each other, agents can perform various semantic maneuvers. A semantic maneuver, as used herein, is a maneuver that is capable of being performed by an agent and is describable through linguistic or logical explanation. For example, a semantic maneuver can include a right turn of an agent, a left turn of the agent, the agent continuing straight, otherwise referred to as lane follow, left lane change, right lane change, and staying in the same spot, or otherwise parking.

Further, agents can perform semantic interactions as part of interacting with each other. Specifically, an agent can yield to another agent. For example, a car can yield to a pedestrian crossing a crosswalk. Additionally, an agent can assert over another agent. For example, an AV can turn in front of another car at an intersection.

In the example environment 100 shown in FIG. 1A, a first vehicle 102 and a second vehicle 104 are in proximity to an intersection. Specifically, the second vehicle 104 is stopped at the intersection while the first vehicle 102 approaches the intersection. In interacting with each other, the second vehicle 104 can perform the semantic interaction of asserting over the first vehicle 102. Alternatively, the second vehicle 104 can perform the semantic interaction of yielding to the first vehicle 102. In this case, the second vehicle 104 yields to the first vehicle 102, and the second vehicle proceeds through the intersection, as illustrated by trajectory 106.

FIG. 1B shows the example operating environment 100 at a later time in relation to the time in the operating environment 100 represented by FIG. 1A. Specifically, FIG. 1B shows the operating environment 100 after the second vehicle 104 yields to the first vehicle 102 and the first vehicle 102 has moved through the intersection. As shown in FIG. 1B, the second vehicle 104 can then proceed through the intersection along trajectory 108. The trajectory 108 of the second vehicle 104 and the trajectory 106 of the first vehicle overlap in the intersection. As will be discussed in greater detail later, this overlap in trajectories can be used in identifying interacting agents for purposes of training an interaction model.

The actions of either or both of the first vehicle 102 and the second vehicle 104 in interacting with each other in the environment 100 can be used to train an interaction model that models semantic interactions between agents in driving environment. Further, the trajectories of either or both the first vehicle 102 and the second vehicle 104 in relation to the interaction between the vehicles 102 and 104 can be used to train the interaction model as well. Additionally, the actions taken by either or both the first vehicle 102 and the second vehicle 104 can ultimately be controlled based on application of the interaction model. For example, the interaction model can be applied to predict that the first vehicle 102 will assert over the second vehicle 104. As follows, the second vehicle 104 can yield to the first vehicle 102 based on this prediction. Conversely, the interaction model can be applied to predict that the second vehicle 104 will yield to the first vehicle 102. As follows, the first vehicle can assert over the second vehicle 104 based on this prediction.

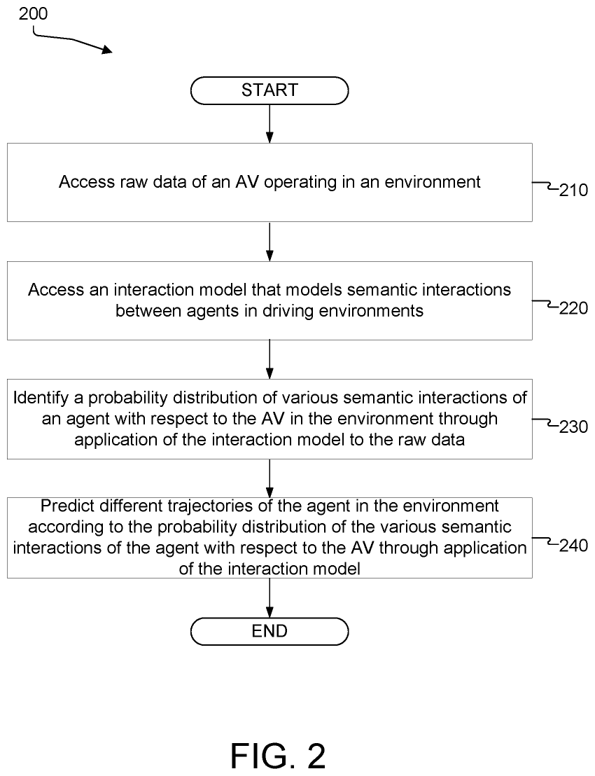

The disclosure now continues with a discussion of applying interaction models to predict semantic interactions and trajectories of agents in an environment based on the predicted semantic interactions. Specifically, FIG. 2 illustrates a flowchart 200 for an example method of predicting trajectories of an agent with respect to an AV based on predicted semantic interactions of the agent in an environment. The method shown in FIG. 2 is provided by way of example, as there are a variety of ways to carry out the method. Additionally, while the example method is illustrated with a particular order of operations, those of ordinary skill in the art will appreciate that FIG. 2 and the modules shown therein can be executed in any order and can include fewer or more modules than illustrated. Each module shown in FIG. 2 represents one or more operations, processes, methods or routines in the method.

At operation 210, raw data of an AV operating in an environment is accessed. Accessed raw AV data can include applicable data that is gathered by an AV as the AV operates in an environment. Specifically, raw AV data can include sensor data that is gathered by sensors as the AV performs various maneuvers in an environment, e.g. a real-world environment or a simulated environment. For example, raw AV data can include data captured by a LIDAR sensor that is indicative of agents surrounding an AV in an environment.

Further, raw AV data can include data that is generated in running a software stack associated with operation of an AV. Specifically, raw AV data include data that is generated by running all or a portion of an applicable software stack in controlling operation of an AV. For example, raw AV data can include an output of running a perception stack. In turn, the output of the perception stack can include an indication of agents in an environment. Further, the output of the perception stack can include trajectories of agents in the environment as the agents move, e.g. relative to an AV. For example, raw AV data can include a trajectory of a car driving next to an AV in a real-world environment.

At operation 220, an interaction model that models semantic interaction between agents in driving environments is accessed. The interaction model can model movements and behaviors of agents to different semantic interactions that can be performed by the agents in an environment. For example, the interaction model can specify that a first vehicle approaching a stop sign for an intersection will assert over a second vehicle that arrives at the intersection after the first vehicle. In another example, the interaction model can specify that a second vehicle that passes a first vehicle at a fast speed will assert over the first vehicle and merge into the lane of the first vehicle.

The interaction model can characterize applicable semantic interactions. Specifically, the interaction model can characterize a yield interaction and an assert interaction. For example, the interaction model can characterize whether a first agent will pass in front of a second agent in an environment. The interaction model can also characterize whether a semantic interaction will occur between agents in an environment. Specifically, the interaction model can characterize that there is no interaction between two agents in an environment. For example, the interaction model can characterize that a pedestrian and a vehicle are far enough away from each other in an environment that they will not interact in the environment.

Further, the interaction model can characterize a probability distribution of different semantic interactions that can occur between agents in an environment. Specifically, the interaction model can characterize a probability distribution that an agent will either assert or yield to another agent in an environment. For example, the interaction model can characterize that there is a 75% chance that a first vehicle will yield and let another vehicle pass it in an adjacent lane.

The interaction model can also characterize trajectories of agents in an environment. Specifically, the interaction model can characterize trajectories of agents in the environment based on predicted semantic interactions of the agents with respect to each other. More specifically, the interaction model can characterize trajectories of an agent in the environment with respect to another agent based on an identified probability distribution of various semantic interactions of the agent with respect to the other agent. For example, the interaction model can predict the trajectory of a first vehicle moving before a second vehicle into an intersection based on a probability distribution of whether the first vehicle will assert over or yield to the second vehicle at the intersection.

As an environment can include many different interacting agents, potentially simultaneously interacting agents, the interaction model can anchor characterizations of semantic interactions and trajectory predictions on a first interaction in a series of different interactions. For example, an environment can include a vehicle trying to make a right turn at a corner onto a street. The environment can also include a pedestrian trying to cross the street at the corner and a bicyclist moving down the street past the pedestrian. In this scenario the vehicle would first interact with the pedestrian and then the bicyclist. Accordingly, the model can anchor its predictions on the pedestrian. Specifically, the interaction model can identify a probability distribution of whether the vehicle will yield to or assert over the pedestrian irrespective of the bicyclist. As follows, the interaction model can predict the trajectory of the vehicle based on the probability distribution of the semantic interactions with the pedestrian irrespective of a semantic interaction with the bicyclist down the street.

At operation 230, a probability distribution of various semantic interactions of an agent with respect to the AV in the environment is identified through application of the interaction model. Specifically, the probability distribution of various semantic interactions of the agent with respect to the AV in the environment can be identified by applying the interaction model based on the raw data of the AV operating in the environment that is accessed at operation 210. Alternatively, a non-interaction between the agent and the AV can be identified through application of the interaction model. For example, the model can identify that an AV and another vehicle are too far away from each other to interact. The model can then be applied repeatedly until the AV and the vehicle are in proximity to each other for interacting. Once they are in proximity for interacting, the model can identify a probability distribution of various semantic interactions between the AV and the vehicle.

At operation 240, different trajectories of the agent in the environment are predicted according to the probability distribution of the various semantic interactions of the agent. Specifically the different trajectories of the agent can be predicted with respect to the AV through application of the interaction model. More specifically, the different trajectories of the agent can be predicted based on whether the agent will assert or yield with respect to the AV.

A trajectory of the agent can be predicted based on whether it is determined that the agent will interact, or otherwise not interact, with another agent. Specifically, if it is determined that the agent and the AV will not interact, then the trajectory of the agent can be identified through a technique that does not include application of the interaction model. More specifically, if it is determined that the agent and the AV will not interact, then one or more geometric-based trajectory prediction models, otherwise modes, can be used in predicting the trajectory of the agent relative to the AV. For example, it is determined that the agent and the AV will not interact, then a right-hand turn trajectory prediction model can be applied to determine the trajectory of the agent relative to the AV.

In predicting the trajectories of the agent relative to the AV, the interaction model can be applied in combination with one or more geometric-based trajectory prediction modes. Specifically, the interaction model and one or more of a right turn model, a left turn model, a lane follow model, a left lane change model, a right lane change model, and a parking stay model can be applied to predict the trajectories of the agent relative to the AV. For example, the interaction model can be applied to predict whether the agent will assert itself in relation to another agent. As follows, a right turn model can be applied to predict the trajectory of the agent in making a right-hand turn based on whether the agent will assert itself over the other agent.

In predicting trajectories of the agent based on both the interaction model and geometric-based trajectory prediction modes, an additive or multiplicative combination of the modes and model can be applied. In the additive approach, one or a combination of an assert semantic interaction can be applied, a yield semantic interaction can be applied, a no semantic interaction and straight geometric mode can be applied, a no semantic interaction and left geometric mode can be applied, a no semantic interaction and right geometric mode can be applied, and a no semantic interaction and another applicable geometric mode can be applied. In the multiplicative approach, one or a combination of a straight geometric mode and assert semantic interaction can be applied, a straight geometric mode and yield semantic interaction can be applied, a straight geometric mode and no semantic interaction can be applied, a left geometric mode and assert semantic interaction can be applied, a left geometric mode and yield semantic interaction can be applied, a left geometric mode and no semantic interaction can be applied, an applicable geometric mode and assert semantic interaction can be applied, an applicable geometric mode and yield semantic interaction can be applied, and an applicable geometric mode and no semantic interaction can be applied.

The interaction model can be based on an extended time window relative to the geometric-based trajectory prediction modes. Specifically, the interaction model can be applied to predict probability distributions and trajectories of agents in an extended time window, e.g. eighteen seconds, relative to the geometric-based trajectory prediction modes. This can lead to improved assert risk prediction, e.g. when compared to operating in a shorter time window. Further, this can mitigate mode collapse in both semantic interaction prediction and trajectory prediction.

Ultimately, operation of the AV can be controlled based on the predicted trajectories of the agent relative to the AV in the environment. Specifically one or more applicable software stacks can control operation of the AV based on the predicted trajectories of the agent relative to the AV in the environment. For example if an agent has a trajectory that crosses in front of the AV, then a planning stack can plan a route for the AV that avoids the agent crossing in front of the AV.

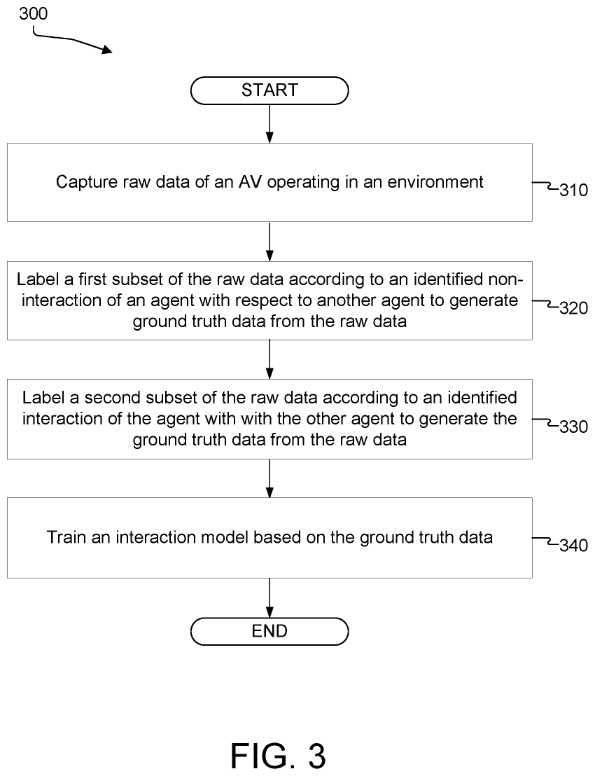

The disclosure now continues with a discussion of training an interaction model to predict semantic interactions and trajectories of agents in an environment. Specifically, FIG. 3 illustrates a flowchart 300 for an example method of labeling data and training an interaction model based on the labeled data. The method shown in FIG. 3 is provided by way of example, as there are a variety of ways to carry out the method. Additionally, while the example method is illustrated with a particular order of operations, those of ordinary skill in the art will appreciate that FIG. 3 and the modules shown therein can be executed in any order and can include fewer or more modules than illustrated. Each module shown in FIG. 3 represents one or more operations, processes, methods or routines in the method.

At operation 310, raw data of an AV operating in an environment is captured. The raw data can include data that is actually captured by an AV operating in a real-world environment. Further, the raw data can include data that is captured by an AV operating in a simulated environment. The raw AV data can include applicable data that described both interactions and non-interactions between agents in an environment.

At operation 320, a first subset of the raw data is labeled according to an identified non-interaction of an agent with respect to another agent to generate ground truth data from the raw data. Specifically, the first subset of the raw data can be labeled to indicate that the first subset of the raw data corresponds to a non-interaction event between the agents. In turn, this can be used to train an interaction model to recognize when agents will not interact with each other.

The non-interaction event between the agents can be recognized according to an applicable technique for identifying when agents will not interact with each other. Specifically, the non-interaction between the agents can be recognized based on identified paths, otherwise trajectories, of the agents in the environment. More specifically, the non-interaction between the agents can be recognized if the paths taken by the agents do not overlap in the environment, e.g. within a specific time frame. For example, if a pedestrian and a car in the environment do not cross paths within an eighteen second time window from a specific time, then the scene in the environment at the specific time can be recognized and labeled as a non-interaction event.

At operation 330, a second subset of the raw data is labeled according to an identified interaction of the agent with respect to the other agent to generate the ground truth data from the raw data. Specifically, the second subset of the raw data can be labeled to indicate that the second subset of the raw data corresponds to an interaction event between the agents. In turn, this can be used to train an interaction model to recognize when agents will interact with each other.

The interaction event between the agents can be recognized according to an applicable technique for identifying when agents will interact with each other. Specifically, the interaction between the agents can be recognized based on the identified paths that are traversed by each of the agents in the environment. More specifically, the interaction between the agents can be recognized if the paths taken by the agents overlap in the environment, e.g. within a specific time frame. For example, if a pedestrian and a car in the environment cross paths within an eighteen second time window from a specific time, then the scene in the environment at the specific time can be recognized and labeled as an interaction event.

In labeling the second subset of the raw data as an interaction event, the type of semantic interaction that either or both of the agents can be identified and also used in labeling the data. Specifically, which of the first or second agent asserted and which of the first or second agent yielded can be identified. Accordingly, the second subset of the raw data can be labeled to indicate which of the first or second agent either asserted or yielded. An applicable technique can be applied to determine which of the agents asserts and which of the agents yields in the raw data. Specifically, the agent that arrives at the overlapping portion of the paths first can be identified as the asserting agent with respect to the other agent. For example, if two pedestrians are crossing paths, which pedestrian first arrives at the point where their paths cross can be identified as the asserting party over the other pedestrian.

At operation 340, an interaction model is trained based on the ground truth data. Specifically, an interaction model can be trained based on the labeled first subset of the raw data and the labeled second subset of the raw data to form the ground truth data. An applicable machine learning model can be trained using an applicable technique as part of training an interaction model based on the ground truth data.

In training the interaction model based on the ground truth data, the interaction model can be trained based on whether the ground truth data is labeled as an interaction event or a non-interaction event. Further, the interaction model can be trained based on the type of semantic interaction that is identified as occurring during an interaction event. Additionally, the interaction model can be trained based on trajectories taken by different agents in the environment in relation to different non-interaction events and interaction events that occur between the agents in the environment.

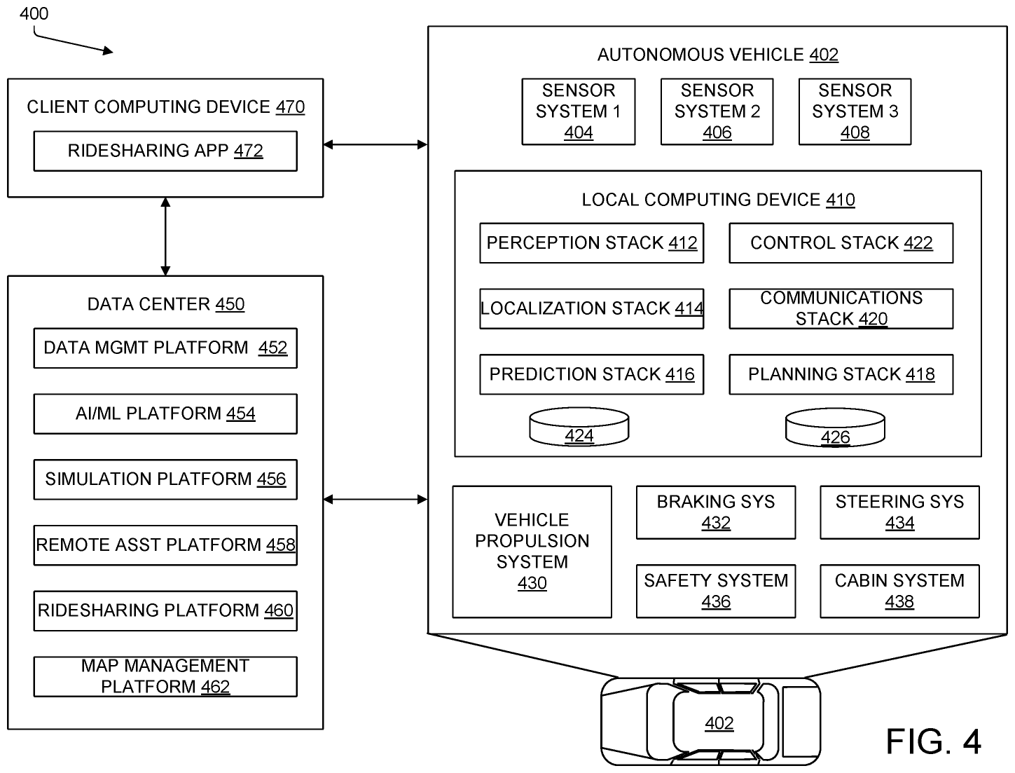

FIG. 4 is a diagram illustrating an example AV environment 400, according to some examples of the present disclosure. One of ordinary skill in the art will understand that, for the AV environment 400 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include one or more types of sensors and can be arranged about the AV 402. For instance, the sensor systems 404-408 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other examples may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some examples, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 414 can determine the AV's position and orientation (pose) using different methods from multiple systems (e.g., GPS, IMUs, cameras, LIDAR, RADAR, ultrasonic sensors, the HD geospatial database 426, etc.). For example, in some cases, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The prediction stack 416 can receive information from the localization stack 414 and objects identified by the perception stack 412 and predict a future path for the objects. In some examples, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

The planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

The control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

The communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 426 can store HD maps and related data of the streets upon which the AV 402 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408, stacks 412-422, and other components of the AV 402 and/or data received by the AV 402 from remote systems (e.g., the data center 450, the client computing device 470, etc.). In some examples, the raw AV data can include HD LIDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

The data center 450 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridesharing platform 460, and a map management platform 462, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 472. The client computing device 470 can be a customer's mobile computing device or a computing device integrated with the AV 402 (e.g., the local computing device 410). The ridesharing platform 4160 can receive requests to pick up or drop off from the ridesharing application 4172 and dispatch the AV 4102 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

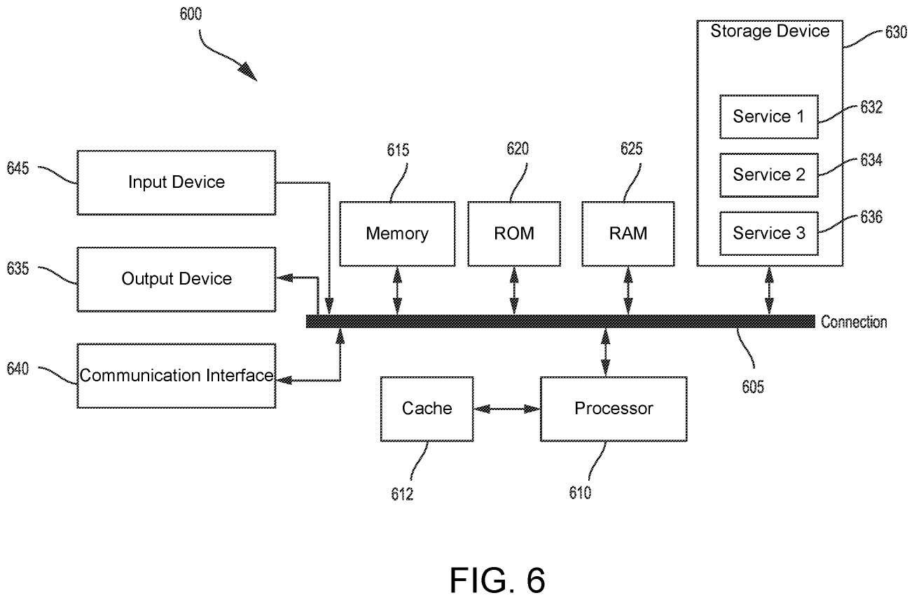

While the autonomous vehicle 402, the local computing device 410, and the autonomous vehicle environment 400 are shown to include certain systems and components, one of ordinary skill will appreciate that the autonomous vehicle 402, the local computing device 410, and/or the autonomous vehicle environment 400 can include more or fewer systems and/or components than those shown in FIG. 4. For example, the autonomous vehicle 402 can include other services than those shown in FIG. 4 and the local computing device 410 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 4. An illustrative example of a computing device and hardware components that can be implemented with the local computing device 410 is described below with respect to FIG. 6.

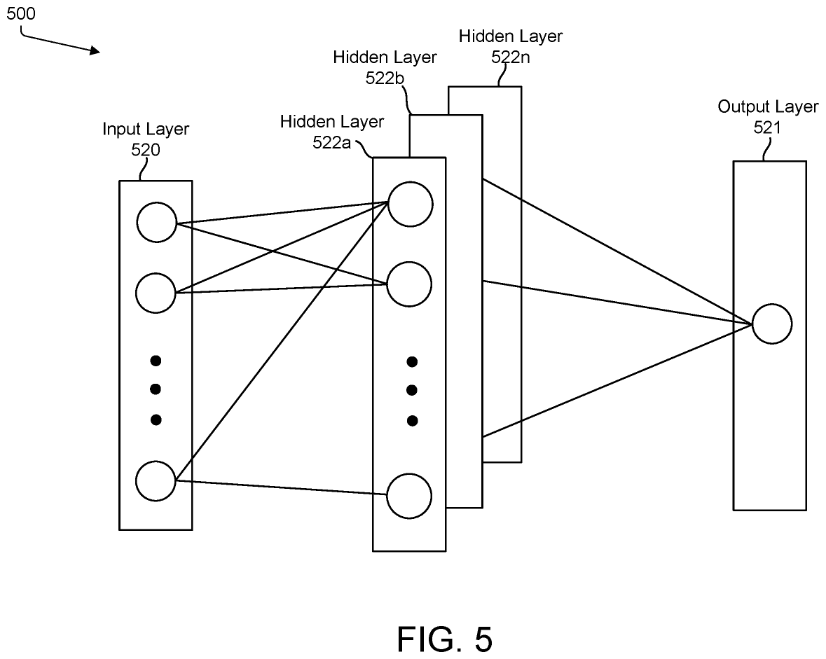

In FIG. 5, the disclosure now turns to a further discussion of models that can be used through the environments and techniques described herein. FIG. 5 is an example of a deep learning neural network 500 that can be used to implement all or a portion of the systems and techniques described herein (e.g., neural network 500 can be used to implement a perception module (or perception system) as discussed above). An input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)∧2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:

Aspect 1. A method comprising: accessing raw data of an autonomous vehicle (“AV”) operating in an environment; accessing an interaction model that models semantic interactions between agents in driving environments; identifying a probability distribution of various semantic interactions of an agent with respect to the AV in the environment through application of the interaction model; and predicting different trajectories of the agent in the environment according to the probability distribution of the various semantic interactions of the agent with respect to the AV through application of the interaction model.

Aspect 2. The method of Aspect 1, wherein the various semantic interactions comprise a yield interaction with respect to the AV.

Aspect 3. The method of any of Aspects 1 and 2, wherein the various semantic interactions comprise an assert interaction with respect to the AV.

Aspect 4. The method of any of Aspects 1 through 3, wherein the interaction model is trained using ground truth data that is generated from captured raw data by labeling a first subset of the captured raw data according to an identified semantic interaction between a first agent and a second agent in the first subset of the captured raw data.

Aspect 5. The method of any of Aspects 1 through 4, wherein an occurrence of the identified semantic interaction is determined based on an overlap in a path of the first agent and a path of the second agent.

Aspect 6. The method of any of Aspects 1 through 5, wherein a type of the identified semantic interaction with respect to the first agent is determined based on whether the first agent arrives before or after the second agent at the overlap in the path of the first agent and the path of the second agent.

Aspect 7. The method of any of Aspects 1 through 6, wherein the interaction model is further trained using the ground truth data that is generated from the captured raw data by labeling a second subset of the captured raw data according to an identified non-interaction between the first agent and the second agent in the second subset of the captured raw data.

Aspect 8. The method of any of Aspects 1 through 7, further comprising: identifying a non-interaction of the agent with respect to the AV in the environment through application of the interaction model; and predicting a trajectory of the agent in the environment based on the non-interaction of the agent with respect to the AV in the environment.

Aspect 9. The method of any of Aspects 1 through 8, wherein predicting the different trajectories of the agent in the environment further comprises predicting the different trajectories according to both the probability distribution of the various semantic interactions of the agent with respect to the AV and one or more geometric-based trajectory prediction modes.

Aspect 10. A system comprising: one or more processors; and at least one computer-readable storage medium having stored therein instructions which, when executed by the one or more processors, cause the one or more processors to: access raw data of an autonomous vehicle (“AV”) operating in an environment; access an interaction model that models semantic interactions between agents in driving environments; identify a probability distribution of various semantic interactions of an agent with respect to the AV in the environment through application of the interaction model; and predict different trajectories of the agent in the environment according to the probability distribution of the various semantic interactions of the agent with respect to the AV through application of the interaction model.

Aspect 11. The system of Aspect 10, wherein the various semantic interactions comprise a yield interaction with respect to the AV.

Aspect 12. The system of any of Aspects 10 and 11, wherein the various semantic interactions comprise an assert interaction with respect to the AV.

Aspect 13. The system of any of Aspects 10 through 12, wherein the interaction model is trained using ground truth data that is generated from captured raw data by labeling a first subset of the captured raw data according to an identified semantic interaction between a first agent and a second agent in the first subset of the captured raw data.

Aspect 14. The system of any of Aspects 10 through 13, wherein an occurrence of the identified semantic interaction is determined based on an overlap in a path of the first agent and a path of the second agent.

Aspect 15. The system of any of Aspects 10 through 14, wherein a type of the identified semantic interaction with respect to the first agent is determined based on whether the first agent arrives before or after the second agent at the overlap in the path of the first agent and the path of the second agent.

Aspect 16. The system of any of Aspects 10 through 15, wherein the interaction model is further trained using the ground truth data that is generated from the captured raw data by labeling a second subset of the captured raw data according to an identified non-interaction between the first agent and the second agent in the second subset of the captured raw data.

Aspect 17. The system of any of Aspects 10 through 16, wherein the instructions further cause the one or more processors to: identify a non-interaction of the agent with respect to the AV in the environment through application of the interaction model; and predict a trajectory of the agent in the environment based on the non-interaction of the agent with respect to the AV in the environment.

Aspect 18. The system of any of Aspects 10 through 17, wherein the instructions further cause the one or more processors to predict the different trajectories according to both the probability distribution of the various semantic interactions of the agent with respect to the AV and one or more geometric-based trajectory prediction modes, as part of predicting the different trajectories of the agent in the environment.

Aspect 19. A non-transitory computer-readable storage medium comprising at least one instruction for causing a computer or processor to: access raw data of an autonomous vehicle (“AV”) operating in an environment; access an interaction model that models semantic interactions between agents in driving environments; identify a probability distribution of various semantic interactions of an agent with respect to the AV in the environment through application of the interaction model; and predict different trajectories of the agent in the environment according to the probability distribution of the various semantic interactions of the agent with respect to the AV through application of the interaction model.

Aspect 20. The non-transitory computer-readable storage medium of Aspect 19, wherein the various semantic interactions include a yield interaction with respect to the AV and an assert interaction with respect to the AV.

Aspect 21. A system comprising means for performing a method according to any of Aspects 1 through 9.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
accessing raw data of an autonomous vehicle (“AV”) operating in an environment;
accessing an interaction model that models semantic interactions between agents in driving environments;
identifying a probability distribution of various semantic interactions of an agent with respect to the AV in the environment through application of the interaction model; and
predicting different trajectories of the agent in the environment according to the probability distribution of the various semantic interactions of the agent with respect to the AV through application of the interaction model.

2. The method of claim 1, wherein the various semantic interactions comprise a yield interaction with respect to the AV.

3. The method of claim 1, wherein the various semantic interactions comprise an assert interaction with respect to the AV.

4. The method of claim 1, wherein the interaction model is trained using ground truth data that is generated from captured raw data by labeling a first subset of the captured raw data according to an identified semantic interaction between a first agent and a second agent in the first subset of the captured raw data.

5. The method of claim 4, wherein an occurrence of the identified semantic interaction is determined based on an overlap in a path of the first agent and a path of the second agent.

6. The method of claim 5, wherein a type of the identified semantic interaction with respect to the first agent is determined based on whether the first agent arrives before or after the second agent at the overlap in the path of the first agent and the path of the second agent.

7. The method of claim 4, wherein the interaction model is further trained using the ground truth data that is generated from the captured raw data by labeling a second subset of the captured raw data according to an identified non-interaction between the first agent and the second agent in the second subset of the captured raw data.

8. The method of claim 1, further comprising:
identifying a non-interaction of the agent with respect to the AV in the environment through application of the interaction model; and
predicting a trajectory of the agent in the environment based on the non-interaction of the agent with respect to the AV in the environment.

9. The method of claim 1, wherein predicting the different trajectories of the agent in the environment further comprises predicting the different trajectories according to both the probability distribution of the various semantic interactions of the agent with respect to the AV and one or more geometric-based trajectory prediction modes.

10. A system comprising:
one or more processors; and
at least one computer-readable storage medium having stored therein instructions which, when executed by the one or more processors, cause the one or more processors to:
access raw data of an autonomous vehicle (“AV”) operating in an environment;
access an interaction model that models semantic interactions between agents in driving environments;
identify a probability distribution of various semantic interactions of an agent with respect to the AV in the environment through application of the interaction model; and
predict different trajectories of the agent in the environment according to the probability distribution of the various semantic interactions of the agent with respect to the AV through application of the interaction model.

11. The system of claim 10, wherein the various semantic interactions comprise a yield interaction with respect to the AV.

12. The system of claim 10, wherein the various semantic interactions comprise an assert interaction with respect to the AV.

13. The system of claim 10, wherein the interaction model is trained using ground truth data that is generated from captured raw data by labeling a first subset of the captured raw data according to an identified semantic interaction between a first agent and a second agent in the first subset of the captured raw data.

14. The system of claim 13, wherein an occurrence of the identified semantic interaction is determined based on an overlap in a path of the first agent and a path of the second agent.

15. The system of claim 14, wherein a type of the identified semantic interaction with respect to the first agent is determined based on whether the first agent arrives before or after the second agent at the overlap in the path of the first agent and the path of the second agent.

16. The system of claim 13, wherein the interaction model is further trained using the ground truth data that is generated from the captured raw data by labeling a second subset of the captured raw data according to an identified non-interaction between the first agent and the second agent in the second subset of the captured raw data.

17. The system of claim 10, wherein the instructions further cause the one or more processors to:
identify a non-interaction of the agent with respect to the AV in the environment through application of the interaction model; and
predict a trajectory of the agent in the environment based on the non-interaction of the agent with respect to the AV in the environment.

18. The system of claim 10, wherein the instructions further cause the one or more processors to predict the different trajectories according to both the probability distribution of the various semantic interactions of the agent with respect to the AV and one or more geometric-based trajectory prediction modes, as part of predicting the different trajectories of the agent in the environment.

19. A non-transitory computer-readable storage medium comprising at least one instruction for causing a computer or processor to:
access raw data of an autonomous vehicle (“AV”) operating in an environment;
access an interaction model that models semantic interactions between agents in driving environments;
identify a probability distribution of various semantic interactions of an agent with respect to the AV in the environment through application of the interaction model; and
predict different trajectories of the agent in the environment according to the probability distribution of the various semantic interactions of the agent with respect to the AV through application of the interaction model.

20. The non-transitory computer-readable storage medium of claim 19, wherein the various semantic interactions include a yield interaction with respect to the AV and an assert interaction with respect to the AV.
